(19) United States
(12) Patent Application Publication
(10) Pub. No.: US 2020/0377002 A1
(43) Pub. Date: Dec. 3, 2020

(54) Modular Furniture for a Vehicle

(71) Applicant: WEBTEZ, INC., Oxnard, CA (US)

(72) Inventor: Peter J. Tezza, II, Oxnard, CA (US)

(21) Appl. No.: 15/929,876

(22) Filed: May 27, 2020

Related U.S. Application Data
(60) Provisional application No. 62/856,058, filed on Jun. 1, 2019.

(51) Int. Cl. B60P 3/42; B60P 3/34; B60N 2/01; B60N 2/34; B60N 3/00; B60N 3/10; B60N 3/16; B60R 16/03; B60R 5/00; B60R 15/02; B60R 15/04; B60H 1/00; B60R 16/033; B60R 16/08

(52) U.S. Cl. CPC B60P 3/42; B60R 16/08; B60N 2/01; B60N 2/34; B60N 3/001; B60N 3/104; B60N 3/16; B60N 3/008; B60R 16/03; B60R 5/00; B60R 15/02; B60R 15/04; B60H 1/00364; B60R 16/033; B60P 3/34

(57) ABSTRACT

A modular receiving vehicle, the vehicle comprising: a plurality of modular connections; a plurality of modular devices comprising: a plurality of modular seats, a plurality of modular furniture; and a plurality of modular appliances; a plurality of utility piping; wherein the utility piping connects from at least one first end of the plurality of modular connections to at least one second end of the plurality of modular connections, wherein the plurality of modular devices are connected to the utility piping at at least one of the first end or second end of the plurality of modular connections; where the plurality of modular devices are attached to the plurality of modular connections; wherein the plurality of modular connections are located on both an interior and an exterior of the vehicle.

### CROSS-REFERENCE TO RELATED APPLICATIONS

This application is a non-provisional of, and claims the benefit of priority from, U.S. Provisional Patent Application No. 62/856,058 filed Jun. 1, 2019.

### FEDERALLY SPONSORED RESEARCH

Not Applicable

### FIELD OF INVENTION

This invention relates to modular furniture for a vehicle, more particularly, to modular furniture for vehicles such as vans, camper vans, and recreational vehicles (RVs) that allow for user customization.

### BACKGROUND

A typical vehicle has a dedicated purpose. For example, a sedan may be dedicated to transportation of passengers, a truck for transportation of cargo or parts, or a RV for camping. Most vehicles are single or possibly dual purpose because once the vehicle is delivered to the end user by the manufacture, the vehicle cannot be reconfigured.

In a typical multi-purpose vehicle, the allocation of space to purpose is fixed at the time of vehicle manufacture. Due to this rigid constraint, the end user cannot customize the vehicle without great difficulty. There is a need for a vehicle that allows a user to customize the allocation of space and purpose to suit the end user's needs. There is also a need for a simplified customization in the form of module units.

### BRIEF SUMMARY OF THE INVENTION

A modular receiving vehicle, the vehicle comprising: a plurality of modular connections; a plurality of modular devices comprising: a plurality of modular seats, a plurality of modular furniture; and a plurality of modular appliances; a plurality of utility piping; wherein the utility piping connects from at least one first end of the plurality of modular connections to at least one second end of the plurality of modular connections, wherein the plurality of modular devices are connected to the utility piping at at least one of the first end or second end of the plurality of modular connections; where the plurality of modular devices are attached to the plurality of modular connections; wherein the plurality of modular connections are located on both an interior and an exterior of the vehicle.

### BRIEF DESCRIPTION OF THE DRAWINGS

FIG. 1 is a top view without a roof of a modular receiving vehicle with a plurality of modular seats and a plurality of modular furniture.

FIG. 2 is another top view without the roof of the modular receiving vehicle with a different combination and layout of the plurality of modular seats and the plurality of modular furniture.

FIG. 3 is a further example of the top view without the roof of the modular receiving vehicle with a third example of another combination and layout of the plurality of modular seats and the plurality of modular furniture.

FIG. 4 is a top view with the roof of the modular receiving vehicle with a plurality of modular appliances.

FIG. 5 is a perspective bottom view of a vehicle frame with a plurality of containers holding the plurality of modular appliances.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art.

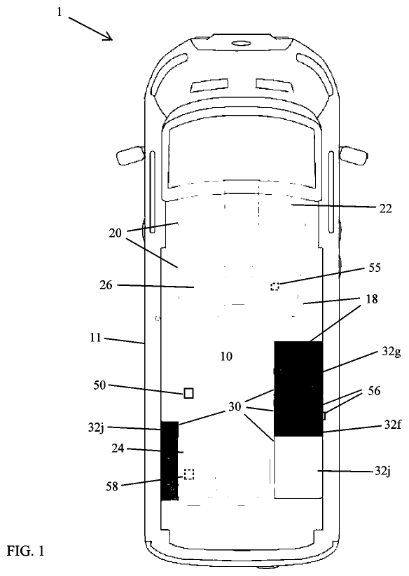

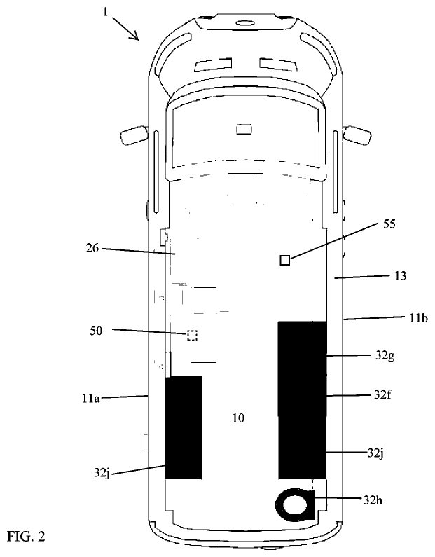

Referring to FIG. 1, in most embodiments, a vehicle 1 may have a vehicle floor 10 surrounded by vehicle walls 11 and a vehicle roof 12. In most embodiments, at least one of the vehicle walls 11 may have a vehicle door 13, as shown in FIG. 2, where the vehicle door 13 may be a hinged door or a sliding door. The vehicle 1 may also have a vehicle frame 15 that may support the vehicle floor 10, the vehicle walls 11, and the vehicle roof 12. In most embodiments, the vehicle 1 may be a van, a camper van, or an recreational vehicle (RV).

In most embodiments, the vehicle floor 10 may support or may retain a plurality of modular devices 18 comprising of a plurality of modular seats 20, a plurality of modular furniture 30, and a plurality of modular appliances 40. The plurality of modular devices 18 may be connected to at least one of the vehicle floor 10, the vehicle walls 11, the vehicle roof 12, and the vehicle frame 15 by a plurality of modular connections 50. In some embodiments, the plurality of modular connections 50 may be on both an interior and an exterior of the vehicle 1. The plurality of modular connections 50 may be placed in any position on at least one of the vehicle floor 10, at least one of the walls 11, and the vehicle roof 12, as seen in FIG. 1.

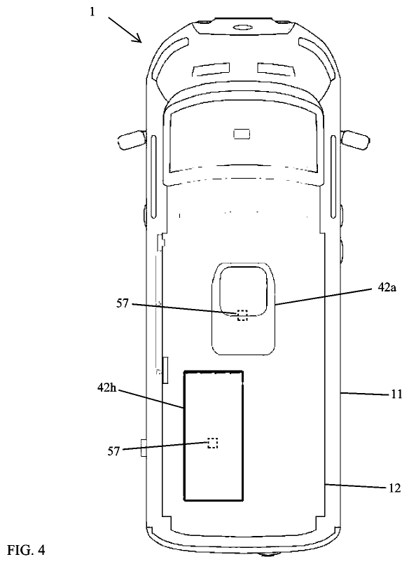

In most embodiments, as illustrated in FIG. 1, the plurality of modular connections 50 may comprise of different types of connectors such as modular seat connections 55, modular furniture connections 56, and modular appliance connections 57, as seen in FIG. 4. Each type of connection 55, 56, 57 connects to at least one of a corresponding modular device 18. In some embodiments, the modular seat connections 55 may be positioned on the vehicle floor 10, whereas the modular furniture connections 56 may be positioned on at least one of the vehicle floor 10 and the vehicle walls 11, internally and externally. In a non-limiting example, the modular furniture connection 56 may attach a stand-alone sink to one of the vehicle walls 11 inside the vehicle 1, whereas a shower head may be attached to a second modular furniture connection 56 on one of the vehicle walls outside the vehicle 1. In another non-limiting example, the modular furniture connection 56 may attach a small refrigerator to one of the vehicle walls 11 and the vehicle floor 10 as seen in FIG. 1, so as to prevent excess moment force about the furniture connectors 56 on the vehicle floor 10. In most embodiments, the modular appliance connectors 57 may be positioned on at least one of the vehicle floor 10, above or below, the vehicle walls 11, the vehicle roof 12, and the vehicle frame 15. In a non-limiting example, the modular appliance connection 57 may attach an air conditioning unit on top of the vehicle roof 12 or to the vehicle frame 15 below the vehicle floor 10.

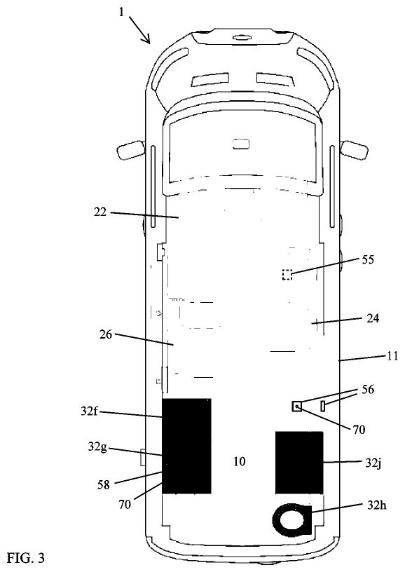

In some embodiments, the plurality of modular connections 50 may be one or more hybrid connections 58. The hybrid connection 58 may act as at least one of the modular seat connections 55, the modular furniture connections 56, and the modular appliance connections 57. In an non-limiting example, a user may use the hybrid connections 58 to connect at least one of the plurality of modular seats 20 while the user travels to a destination. Once the user reaches the desired destination, the user may disconnect the at least one plurality of modular seats 20 from the hybrid connection 58 and may connect at least one of the plurality of furniture 30, such as a fold out bed to the same hybrid connection 58, as seen in FIGS. 1 and 3. The hybrid connections 58 may reduce the number of connections needed, thus saving on costs associated with parts and installation labor. FIGS. 1-4 illustrate some but not all of the plurality of modular connections 50, including the modular seat connections 55, the modular furniture connections 56, the modular appliance connections 57, and they hybrid connection 58.

In some embodiments, at least one of the plurality of modular connections 50 may use a plurality of fasteners 52. In some embodiments, at least one of the modular connections 50 may have built-in threaded apertures 53 in which a bolt or a machine screw may be threaded through the each of the modular connection 50 when mated with the modular device 18. In other embodiments, at least one of the plurality of connections 50 allows at least one of the plurality of modular devices 18 to rotate. For example, the at least one of the plurality of devices 18 may be a seat connected to at least one rotatable modular connections 54 on the vehicle floor 10, which may allow the user to rotate said seat only when the seat may be attached to said rotatable modular connection 54. In a similar example, if the seat requires one or more modular connections 50 in additional to the rotatable modular connection 54, said seat may be prevented from rotating until the one or more modular connections 50 are unattached, in which case, said seat would rotate about the rotatable modular connection 54. The rotatable modular connection 54 may allow for easy rearranging of at least one of the plurality of modular devices 18.

In some embodiments, the plurality of modular connections 50 may be a keyed connection 59 to prevent at least one of the plurality of modular devices 18 from facing a particular direction. For example, the at least one of the modular plurality of modular connections 50 may be the keyed connection 59 so that when the sink may be installed within the vehicle 1, said sink only faces towards a center of the vehicle 1. The keyed connection 59 may be utilized to prevent exposure of pipes or wires that may be connected to at least one of the plurality of modular devices 18.

In most embodiments, the plurality of modular seats 20 may include at least one of a single seat 22, a double seat 24, and a triple seat 26. In some embodiments, the plurality of modular seats 20 may be in a driving position facing a front of the vehicle 1. The plurality of modular seats 20 may then be moved or rotated so that the plurality of modular seats 20 may be perpendicular to the driving position and facing inwards or outwards along one of the vehicle walls 11 as seen in FIG. 2, or facing towards a rear of the vehicle 1.

In some embodiments, at least one of the double seat 24 and the triple seat 26 of the plurality of modular seats 20 may have additional functions such as converting to a seat bed 28. In a non limiting example, the user may position the double seat 24 and the triple seat 26 of the plurality of seats 20 in the driving position according to FIG. 1. Once the user reaches the desired destination, the user may rotate the triple seat 26, which acts as a futon bed for an adult, to align with the vehicle wall 11a, as seen in FIGS. 2-3. The double 24 seat can be moved from a rear of the vehicle 1 to a now vacant space across from the triple seat 26 and align with the vehicle wall 11b, which may act as a child sized futon bed, as illustrated in FIG. 3.

In most embodiments, the plurality of furniture 30 may be any piece of furniture cable of fitting into the vehicle 1. In most embodiments, the plurality of furniture 30 may be single pieces of furniture 32 or combination pieces of furniture 34 that combines one or more pieces of furniture, such as a counter and sink stand. In most embodiments, the plurality of furniture 30 includes, but not limited to, at least one of a cabinet 32a, a table 32b, a counter 32c, an electrical outlet 32d, an electric or gas stove top 32e, a refrigerator 32f, a sink 32g, a toilet 32h, a shower 32i, a dresser 32j, and a fold out bed 32k. In a non-limiting example, the user may normally position the plurality of seats 20 and the plurality of furniture 30, including a stove and sink combination 34a, the table 32b, the stove 32e, the dresser 32j, in a position as shown in FIG. 1. The user may then decide to rearrange the plurality of modular seats 20 and the plurality of modular furniture 30 for an upcoming trip by removing the double seat 24 and adding the cabinet 32a and the toilet 32h, as seen in FIG. 2.

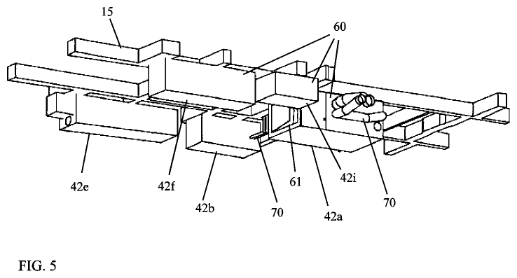

In most embodiments, the plurality of modular appliances 40 may include one or more single piece appliances or combinations thereof. For example, the plurality of modular appliances 40 may include, but not limited to, at least one of an air conditioner 42a, a heater 42b, a refrigerator pump 42c, a storage 42d, a tank 42e, a propane tank 42f, a compressor 42g, a solar panel 42h, batteries 42i, and one or more pumps 42j. The modular appliance connections 56 may be directly attached to at least one of the plurality of appliances 40. In most embodiments, the plurality of appliances may be attached to the both the internal and external of the vehicle 1 by at least one of the modular appliance connections 57. In a non-limiting example, referring to FIG. 4, the air conditioner 42a and the solar panel 42h are stored on vehicle roof 12 and the batteries 42i for the solar panel 42h are stored in the rear of the vehicle floor 10, not shown. For illustrative purposes, only one of the modular appliance connections 57 may be shown for each of the plurality of modular appliances 40, as seen in FIG. 4, however, each of the plurality of appliances 50 may be secured by multiple modular appliance connections 57. In other embodiments, the plurality of modular appliances 40 may be attached to the bottom of the vehicle floor 10. Referring to the non-limiting example above, the user may want to increase solar power generation for an upcoming trip. The user may detach the air conditioner 42a from the top of the vehicle roof 12 and reattach the air conditioner 42a to at least one of the modular connections 40 under the vehicle floor 10. After removing the air conditioner 42a, the user may attach another solar panel 42h to the vacant modular appliance connection 57 on the vehicle roof 12. In preferred embodiments, the plurality of modular appliances 40 may be attached to the vehicle frame 15 for improved support and retention of the appliance, as seen in FIG. 5.

In some embodiments, the modular appliance connections 57 may be at least one container 60. Referring to FIG. 5, the container 60 may have at least one opening 61 that allows access into a cavity of the container 60. In most embodiments, the container 60 may be stored underneath the vehicle floor 10, referring to FIG. 5. In other embodiments, the container 60 may be store in the vehicle 1 or on the vehicle roof 12. The at least one container 60 may be sized to fit at least one of the plurality of appliances 40 snugly to prevent horizontal movement within the container and without fasteners. In other embodiments, the container 60 contains a plurality of fasteners 62 to secure at least one of the plurality of appliances 40. In some embodiments, the plurality of fasteners 52 of the the modular appliance connections 57 may also pass through the container 60 to secure at least one of the plurality of appliances 40 directly to the container 60 and at least one of the vehicle floor 10, the vehicle walls 11, the vehicle roof 12, and the vehicle frame 15 of the vehicle 1. In some embodiments, the container 60 may be locked with a locking mechanism to prevent accidental or intentional opening of said container 60.

Referring again back to the example above, the air conditioner 42a may be stored in the container 60 attached to the vehicle frame 15 underneath the vehicle floor 10 as seen in FIG. 5. The container 60 may provide extra protection to at least one of the plurality of appliances 40 from external hazards, such as weather, road conditions, debris, and theft, or a combination thereof.

In most embodiments, the plurality of modular connections 50 may contain utility piping 70. The utility piping 70 may include, but not limited to, one or more water pipes, waste pipes, gas pipes, air vents, exhaust vents, electrical pipes, or a combination thereof. In the above example, the air conditioner 42a that may be connected to at least one of the modular appliance connection 57 or the container 60, which may have utility piping 70 such as air vents, as seen in FIG. 5. The utility piping 70 may be installed throughout the vehicle 1. In another example, the modular seat connections 55 may have utility piping 70 that includes electrical pipes the connect to one or more seat warmers in the plurality of the modular seats 20. In a further non-limiting example, the modular furniture connections 56 and hybrid connection 58 may have utility piping 70 to drain water when one of the plurality of furniture may be connected, as seen in FIG. 3. In another example, a sink and stove combination piece of furniture may have separate utility piping 70 for propane gas, water, and electricity that are all bundled together at one of the plurality of modular connections 50.

In some embodiments, the utility piping 70 may connect from a first connector of the plurality of modular connections 50 to a second connector of the plurality of the modular connections 50. For example, the solar panel 42h may be connected to at least one of the modular appliance connections 57 on top of the vehicle roof 12 that may contain utility piping 70, such as electrical pipes, that may be connected to the hybrid connection 58 for an electrical outlet (furniture) and a storage battery (appliance) combination. The utility piping 70, in this example, may form a circuit 74 from the solar panel 42h on the vehicle roof 12 to both the electrical outlet for use by the user to power a portable device and to the storage battery when the electrical outlet is not in use. In some embodiments, the vehicle may have a plurality of separate utility circuits 74 formed from different groups of the utility piping 70 or a single circuit 74 formed from a majority of the utility piping 70 attached to a majority of the plurality of modular connections 50.

In most embodiments, the utility piping 70 may be be installed from one of the plurality of modular connections 50 to two or more different modular connections 50. In a non-limiting example, a water storage tank 42e may be stored on the vehicle roof 12, the modular appliance connection 57 with the utility piping 70 may connected to the water storage tank and the utility piping 70 may also be connected to other multiple modular furniture connections 56, such as the sink 32g, the toilet 32h, and the shower 32i. Gravity or a water pump may cause the water tank to feed all three of the sink 32g, the toilet 32h, and the shower 32i from the same source. The sink 32g, the toilet 32h, and the shower 32i may drain into another water storage tank attached to the frame 15 of the vehicle 1 through another set of utility piping 70 connected at the plurality of modular connections 50.

In some embodiments, the utility piping 70 may contain at least one valve 76 to close or seal at least one of the utility piping 70 to prevent leakage from or debris into said utility piping 70 at each end of the utility piping 70. In some embodiments, the valve 76 may act as a three-way valve 78 that may allow one end of the utility piping 70 in the circuit 74 to change states from opened, closed, or pass-through. In the non-limiting example above, the valves 76 attached to the utility piping 70 among the modular furniture connections 56 may allow the user to disconnect and/or reconnect the sink 32g from and to other modular furniture connection 56, such as the modular furniture connections 56 that may have been disconnected from toilet 32h or the shower 32i, with minimal fluid leakage. The valves 76 may allow the user to attached and arrange the plurality of modular furniture 30 to any modular furniture connection 56 that may connected to the circuit 74 of the utility piping 70, depending on the user's desired layout.

In some embodiments, the plurality of modular connections 50 may have one or more connector covers 51 for covering the plurality of modular connections 50. The connector covers 51 may conceal and protect the plurality of modular connections 50 and the utility piping 70. Referring to the example above, when the shower 32i may be removed, a first at least one of the modular furniture connections 56 on the vehicle wall 11 and a second at least one of the modular furniture connections 56 on the vehicle floor 10 may be covered with the connector cover 51 to protect the first and second of the modular furniture connections 56 and utility piping 70 from debris as well as aesthetically please the user by concealing said connections 56 and piping 70.

In some embodiments, the plurality of modular devices 18 may be removed entirely from the interior of the vehicle 1 so that other items may be stored or transported in the vehicle 1. For example, all of the plurality of devices 18 may be removed from the vehicle 1 and each of the plurality of connections 50 may be covered with connector covers 51, so that said vehicle 1 may store a plurality of bikes, rafts, supplies, tents, furniture, or other stored cargo and parts with ease. In some embodiments, the plurality of modular connections 50 may have one or more loops or hooks so that cargo can be secured to at least one of the vehicle floor 10, at least one of the vehicle walls 11, and the vehicle roof 12 with straps, ropes, bungee cords, or other conventional securing means.

With respect to the above description, it is to be realized that any of the above embodiments can readily be combined with any one or more embodiments also listed above. In particular, with respect to the above description, it is to be realized that the optimum dimensional relation ships for the parts of the present invention may include variations in size, materials, shape, form, function and manner of operation. The assembly and use of the present invention are deemed readily apparent and obvious to one skilled in the art.

1. A modular receiving vehicle, the vehicle comprising:
a plurality of modular connections;
a plurality of modular devices comprising: a plurality of modular seats, a plurality of modular furniture; and a plurality of modular appliances;
where the plurality of modular devices are attached to the plurality of modular connections;
wherein the plurality of modular connections are located on both an interior and an exterior of the vehicle.

2. The vehicle of claim 1, wherein the plurality of modular seats include at least one of a single seat, double seat, and a triple seat.

3. The vehicle of claim 2, wherein the double seat and the triple seat can be adjusted into a bed

4. The vehicle of claim 1, wherein the plurality of modular furniture include at least one of a cabinet, a table, a counter, an electrical outlet, an electrical or gas stove, a refrigerator, a sink, a toilet, a shower, a dresser, and a fold out bed.

5. The vehicle of claim 1, wherein the plurality of modular appliances include at least one of an air conditioner, a heater, a refrigerator pump, a storage, a tank, a propane tank, a compressor, and a solar panel, and at least one battery.

6. The vehicle of claim 1, wherein the plurality of modular appliances are connected to the plurality of modular connections positioned on top of the vehicle roof.

7. The vehicle of claim 1, wherein the plurality of modular appliances are connected to the plurality of modular connections positioned underneath the vehicle; wherein the plurality of connections are attached to the frame of the vehicle.

8. The vehicle of claim 1, wherein the plurality of modular connections further comprises:
modular seat connections;
modular furniture connections; and
modular appliance connections.

9. The vehicle of claim 1, wherein the modular appliance connections include at least one container with a lid; wherein the container retains at least one of the plurality of devices.

10. The vehicle of claim 8, wherein the modular appliance connections include utility piping connected to the modular furniture connections, wherein each of the modular appliances connect by the utility piping service at least one of the plurality of furniture.

11. The vehicle of claim 8, wherein at least one of the plurality of modular connections is a hybrid connector; wherein the hybrid connector connects to at least two of the modular seat connections, the modular furniture connections, and the modular appliance connections.

12. A modular receiving vehicle, the vehicle comprising:
a plurality of modular connections;
a plurality of modular devices comprising: a plurality of modular seats, a plurality of modular furniture; and a plurality of modular appliances;
a plurality of utility piping; wherein the utility piping connects from at least one first end of the plurality of modular connections to at least one second end of the plurality of modular connections, wherein the plurality of modular devices are connected to the utility piping at at least one of the first end or second end of the plurality of modular connections;
where the plurality of modular devices are attached to the plurality of modular connections;
wherein the plurality of modular connections are located on both an interior and an exterior of the vehicle.

13. The vehicle of claim 12, wherein the plurality of modular connections further comprises:
modular seat connections;
modular furniture connections; and
modular appliance connections.

14. The vehicle of claim 13, wherein the modular appliance connections include at least one container with a lid; wherein the container retains at least one of the plurality of devices.

15. The vehicle of claim 13, wherein at least one of the plurality of modular connections is a hybrid connector; wherein the hybrid connector connects to at least two of the modular seat connections, the modular furniture connections, and the modular appliance connections.

16. The vehicle of claim 12, further comprising: a plurality of connection covers, wherein at the plurality of connection covers is used to cover the plurality of modular connections and the plurality of utility piping.

17. The vehicle of claim 12, wherein at least one of the plurality of modular connections is a rotatable modular connection when connected to at least one of the plurality of devices.

18. The vehicle of claim 12, wherein the at least one of the plurality of modulate connections is a keyed modular connection; wherein the keyed modular connection prevents at least one of the plurality of devices from being aligned in at least one direction.

19. The vehicle of claim 12, wherein the utility piping forms one or more separate circuits that connect to the plurality of modular connections.

20. The vehicle of claim 19, wherein the utility piping has at least one valve connected to at least one end of the utility piping at at least one of the plurality of modular connections;
wherein the at least one valve acts as a three-way valve in conjunction with the one or more separate circuits.
